(19) United States
(12) Patent Application Publication
(10) Pub. No.: US 2005/0235510 A1
(43) Pub. Date: Oct. 27, 2005

(54) Inspection fixture

(75) Inventor: Trao B. Ly, Mountain View, CA (US)

Correspondence Address: Michael B. Einschlag;Rosenlaw & Einschlag, 25680 Fernhill Drive, Los Altos Hills, CA, 94024, US

(73) Assignee: Riospring, Inc., Milpitas, CA (US)

(21) Appl. No.: 11/108,344

(22) Filed: Apr. 18, 2005

Related U.S. Application Data
(60) Provisional application No. 60/564,354, filed on Apr. 21, 2004.

(51) Int. Cl. G01B 5/00

(52) U.S. Cl. 33/549

(57) ABSTRACT

One embodiment of the present invention is a fixture for use in inspecting a product, which fixture includes: (a) a base including a first standing mechanism and a second standing mechanism; and (b) a clamp supported by the base which is adapted to secure the product on the base; wherein the first standing mechanism is adapted to support the fixture on a platform in a first orientation; and wherein the second standing mechanism is adapted to support the fixture on the platform in a second orientation.

This application claims the benefit of U.S. Provisional Application No. 60/564,354 which was filed on Apr. 21, 2004 and which is incorporated herein by reference.

### TECHNICAL FIELD OF THE INVENTION

One or more embodiments of the present invention relate to inspection in manufacturing miniature or small products, and more particularly, to an inspection fixture used in manufacturing miniature or small products.

### BACKGROUND OF THE INVENTION

In manufacturing a miniature or small product such as, for example and without limitation, a head stack assembly (HSA) of a small form factor disk drive, to ensure quality and performance of the product, a number of dimensions of the product are inspected to determine whether they meet predetermined requirements. Consider an HSA of a small form factor disk drive as depicted in a top view and a side view thereof shown in FIG. 1 as an example of such a miniature or small product. Relevant dimensions for such an HSA include, for example and without limitation: (a) pivot-to-slider distance 11; (b) suspension hollow width 12; (c) first slider center-to-side distance 13; (d) first slider thickness 14; (e) first suspension height 15; (f) second suspension height 16; (g) HSA coil height 17; and (h) HSA coil thickness 18.

To determine whether the relevant dimensions meet the predetermined requirements, the product is typically inspected by a human operator using a microscope system having a video camera (or image sensor), a monitor, and optionally, a computer that is commercially available from an inspection system supplier such as, for example and without limitation, NC Measurements Corporation (www.ncmeasurements.net) of Cary, N.C. To carry out the inspection, the product is secured on an inspection fixture, and the product, along with the inspection fixture, is placed on a platform in view of the video camera. Then, using images provided by the video camera, the operator compares dimensions of the HSA provided by the microscope system with dimensions of datum references on the inspection fixture also provided by the microscope system.

Conventionally, to inspect dimensions in a different view of the product, the product is unloaded from the inspection fixture, turned, and reloaded onto the inspection fixture or onto a different inspection fixture so that a different view is visible in the video camera. Such steps of unloading and reloading the product take time, and therefore, negatively affect productivity in manufacturing. In addition, further handling of the product increases the probability of electrical and mechanical damage to the product.

Newer inspection systems have been developed that utilize multiple video cameras or sophisticated optical arrangements to enable simultaneous inspection of a product in different views. However, such inspection systems are costly.

In light of the above, there is a need in the art for an apparatus that solves one or more of the above-identified problems.

### SUMMARY OF THE INVENTION

One or more embodiments of the present invention solve one or more of the above-identified problems. In particular, one embodiment of the present invention is a fixture for use in inspecting a product, which fixture comprises: (a) a base comprising a first standing mechanism and a second standing mechanism; and (b) a clamp supported by the base which is adapted to secure the product on the base; wherein the first standing mechanism is adapted to support the fixture on a platform in a first orientation; and wherein the second standing mechanism is adapted to support the fixture on the platform in a second orientation.

### BRIEF DESCRIPTION OF THE DRAWINGS

FIG. 1 shows a top view and a side view of a head stack assembly (HSA) of a small form factor disk drive;

FIG. 2 shows a perspective view of a fixture that is fabricated in accordance with one or more embodiments of the present invention and which is useful for inspecting an HSA such as the one shown in FIG. 1;

FIGS. 3A and 3B show a top view and a side view, respectively, of the fixture shown in FIG. 2 with the HSA shown in FIG. 1 loaded on the fixture; and FIG. 3C shows a clamping unit of the fixture; and

FIGS. 4A, 4B, and 4C illustrate an inspection system that is fabricated in accordance with one or more embodiments of the present invention, which inspection system includes the fixture shown in FIG. 2—in FIGS. 4A-4C the HSA shown in FIG. 1 is loaded on the fixture, and the fixture is disposed in three different orientations.

### DETAILED DESCRIPTION

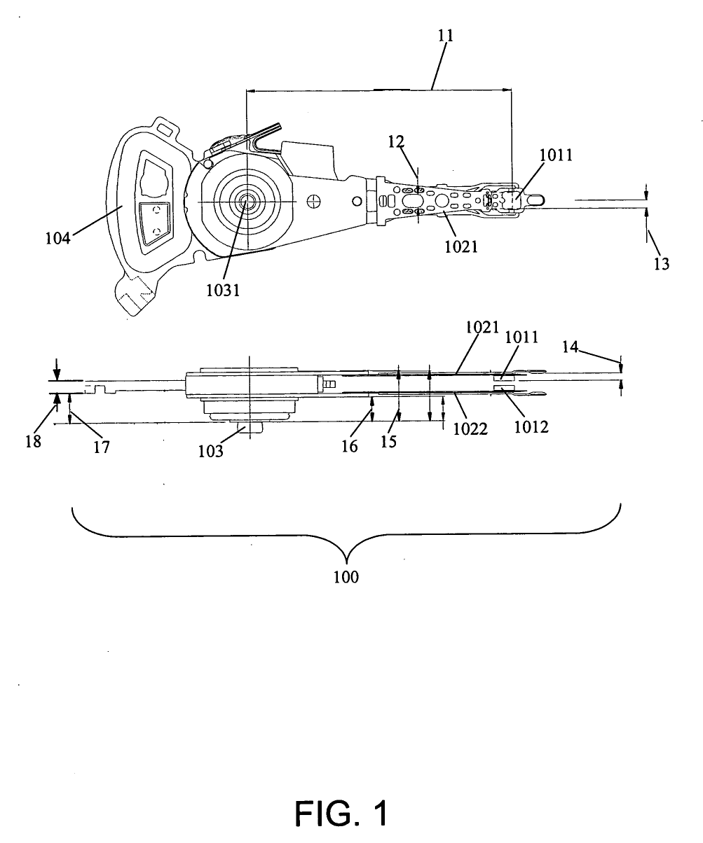

FIG. 1 shows a top view and a side view of head stack assembly 100 (HSA 100) of a small form factor disk. As shown in FIG. 1, HSA 100 includes first head 1011, second head 1012, first suspension 1021, second suspension 1022, HSA pivot 103, and HSA coil 104. In manufacturing HSA 100, a number of dimensions of HSA 100 need to be inspected. Referring to FIG. 1, such dimensions include, for example and without limitation, (a) pivot-to-slider distance 11; (b) suspension hollow width 12; (c) first slider center-to-side distance 13; (d) first slider thickness 14; (e) first suspension height 15; (f) second suspension height 16; (g) HSA coil height 17; and (h) HSA coil thickness 18.

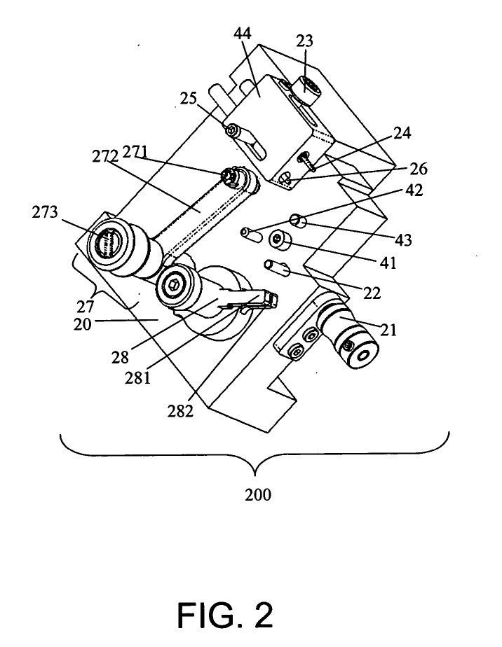

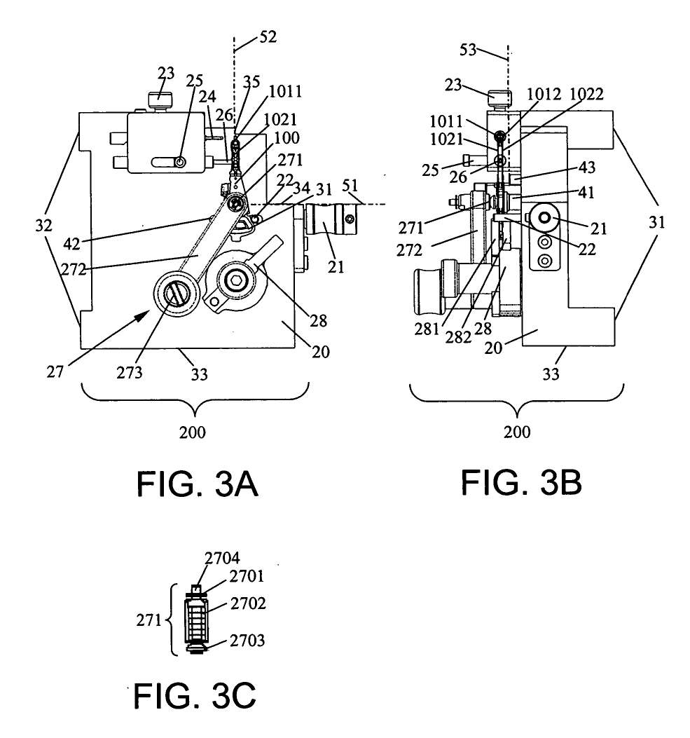

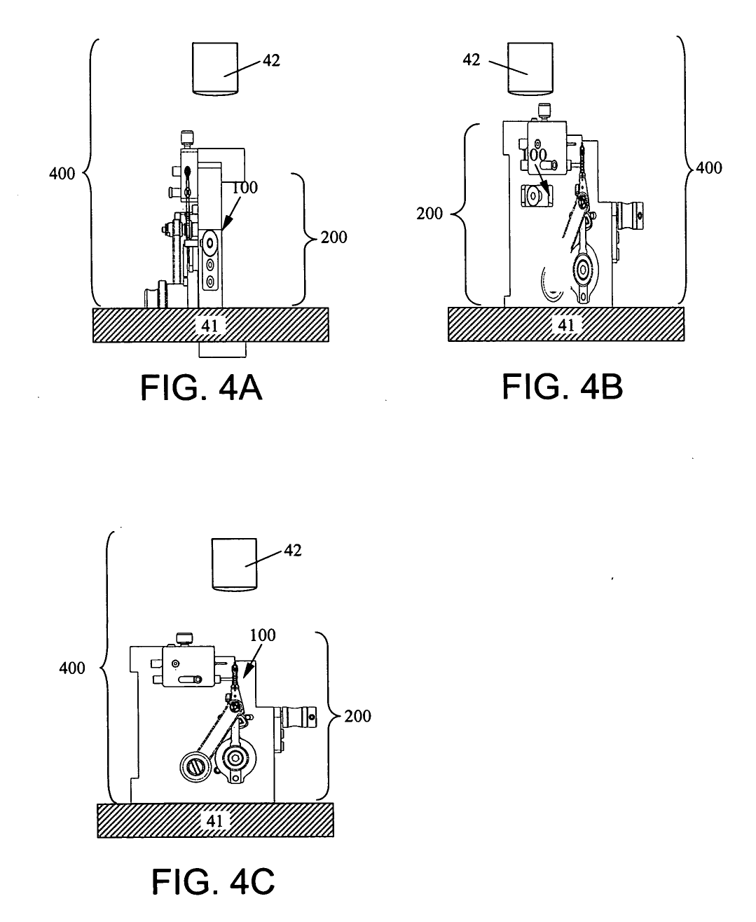

FIG. 2 shows a perspective view of fixture 200 that is fabricated in accordance with one or more embodiments of the present invention and which is useful for inspecting an HSA such as HSA 100 shown in FIG. 1. FIGS. 3A and 3B show a top view and a side view, respectively, of fixture 200 with HSA 100 being loaded thereon. FIGS. 4A, 4B, and 4C illustrate inspection system 400 that is fabricated in accordance with one or more embodiments of the present invention, which inspection system 400 includes fixture 200—in FIGS. 4A-4C HSA 100 is loaded on fixture 200, and fixture 200 is disposed in three different orientations.

As shown in FIGS. 2, 3A, and 3B, in accordance with one or more embodiments of the present invention, fixture 200 includes base 20 that is adapted to support other components of fixture 200. Further, as shown in FIGS. 3A and 3B, with reference to FIGS. 4A, 4B, and 4C, in accordance with one or more embodiments of the present invention, base 20 includes first standing mechanism 31, second standing mechanism 32, and third standing mechanism 33 wherein standing mechanisms 31, 32, and 33 are each adapted to support fixture 200 in a different orientation of fixture 200. As shown in FIGS. 3A and 3B, each of standing mechanisms 31, 32, and 33 forms a portion of base 20, and each includes a substantially flat surface. As further shown in FIGS. 3A and 3B, each such substantially flat surface is substantially parallel to a reference plane which is perpendicular to the plane of the paper and includes dotted lines 53, 52, and 51, respectively. In accordance with one or more embodiments of the present invention, standing mechanisms 31, 32, and 33 support fixture 200, and hence HSA 100, in three different orientations on platform 41 shown in FIGS. 4A, 4B, and 4C.

As shown in FIGS. 3A and 3B, in accordance with one or more embodiments of the present invention, first standing mechanism 31 and second standing mechanism 32, respectively, include leg structures extending from one side of base 20. In accordance with such embodiments, each of first standing mechanism 31 and second standing mechanism 32 includes discrete units, which discrete units may provide edges that serve as datum references used in inspecting HSA 100, and such discrete units may also be useful in conserving material used to fabricate base 20. Further, as shown in FIGS. 3A and 3B, in accordance with one or more embodiments of the present invention, third standing mechanism 33 forms a substantially flat side of base 20. As one or ordinary skill in the art knows, a datum reference is a plane, a point or an axis from which a measurement is made.

FIGS. 4A, 4B, and 4C show fixture 200 (having HSA 100. loaded thereon) being supported on platform 41 of inspection system 400 under image sensor 42 in three different orientations by standing mechanism 31, standing mechanism 32, and standing mechanism 33, respectively. As such, three different views of HSA 100 are presented to image sensor 42 for inspection. In accordance with one or more embodiments of the present invention, inspection system 400 further includes, for example and without limitation, an electronic microscope (not shown) that is commercially available from suppliers such as, for example and without limitation, NC Measurements Corporation (www.ncmeasurements.net) of Cary, N.C. Further, in accordance with one or more embodiments of the present invention, platform 41 provides a substantially flat surface upon which fixture 200 stands.

In accordance with one or more embodiments of the present invention, one or more surfaces of base 20 includes one or more straight lines that provide one or more datum references that are used in inspecting HSA 100. For example, as shown in FIGS. 3A and 3B, in accordance with one or more embodiments of the present invention, base 20 includes first edge 34 and second edge 35 which provide first datum reference 51 and second datum reference 52, respectively, used in inspecting HSA 100.

In accordance of one or more embodiments of the present invention, base 20 (including standing mechanisms 31, 32 and 33 and edges 34 and 35) is fabricated using one or more processes that are well known to those of ordinary skill in the art such as, for example and without limitation, casting and cutting. In accordance of one or more embodiments of the present invention, base 20 is made of 17-4 PH steel.

In accordance with one or more embodiments of the present invention, fixture 200 includes datum block 43. As shown in FIGS. 2 and 3B, in accordance with one or more embodiments of the present invention, datum block 43 is a cylindrical block that has a substantially flat top surface. The substantially flat top surface is substantially parallel to the surface of base 20 and provides third datum reference 53. In accordance with one or more such embodiments, datum block 43 is commercially available and is made of 440 series stainless steel. As well known to one of ordinary skill in the art, a portion of datum block 43 can be inserted into, and tightly fit, a receptacle in the surface of base 20 so that its flat surface is elevated and disposed at a predetermined height above the surface of base 20.

As further shown in FIGS. 2, 3A and 3B, in accordance with one or more embodiments of the present invention, fixture 200 includes a number of components that support and secure HSA 100. As shown in FIGS. 2, 3A and 3B, in accordance with one or more embodiments of the present invention, fixture 200 includes HSA pivot support 41, which HSA pivot support 41 includes a receptacle that receives and supports HSA pivot 103 (shown in FIG. 1). As shown in FIGS. 2 and 3B, in accordance with one or more embodiments of the present invention, HSA pivot support 41 is a cylindrical block that has a cylindrical receptacle and a substantially flat, ring-shaped, top surface. HSA pivot support 41 is disposed on the same side of base 20 as datum block 43. In accordance with one or more such embodiments, the cylindrical receptacle has a diameter that is substantially equal to, but slightly larger than, the diameter of HSA pivot 103 so that HSA pivot 103 will slip-fit into the cylindrical receptacle and support rotation of HSA 100 when HSA 100 is loaded onto fixture 200. In accordance with one or more embodiments of the present invention, HSA pivot support 41 supports the weight of HSA 100 through an inside surface of the cylindrical receptacle when fixture 200 stands on second standing mechanism 32 or third standing mechanism 33. In accordance with one or more further embodiments, in use, the substantially flat, ring-shaped, top surface of HSA pivot support 41 contacts a portion of HSA 100 when HSA 100 is loaded onto fixture 200 and, whenever fixture 200 is oriented so that it stands on first standing mechanism 31, HSA pivot support 41 supports the weight of HSA 100. In accordance with one or more embodiments of the present invention, HSA pivot support 41 is made of 440 series stainless steel. As well known to one of ordinary skill in the art, a portion of HSA pivot support 41 can be inserted into, and tightly fit, a receptacle in the surface of base 20 so that its top surface is disposed at a predetermined height above the surface of base 20.

As further shown in FIGS. 2, 3A, and 3B, in accordance with one or more embodiments of the present invention, fixture 200 includes HSA clamp 27 which is used to secure HSA 100 on fixture 200 at HSA pivot 103. In accordance with one or more such embodiments, HSA clamp 27 includes clamping unit 271, clamp arm 272, and clamp pivot 273, and HSA clamp 27 is disposed on the same side of base 20 as HSA pivot support 41. As shown in FIGS. 3A and 3B, a portion of clamp pivot 273 is inserted into a receptacle in the surface of base 20 so that a depth of insertion of clamp pivot 273 into the receptacle can be varied. One end of clamp arm 272 is coupled to clamp pivot 273 so that clamp arm 272 can rotate around clamp pivot 273, and another end of clamp arm 272 is connected to clamping unit 271.

In accordance with one or more embodiments of the present invention, clamp pivot 273 is loaded with a spring (not shown), which spring: (a) is attached to the bottom of the receptacle in base 20; and (b) exerts a force that pulls clamp pivot 273 vertically towards base 20. As a result, clamp pivot 273 exerts a force on clamp arm 272, and clamp arm 272, in turn, transmits the force to clamping unit 271 which causes clamping unit 271 to clamp HSA 100 at HSA pivot 103 in the manner described below.

In accordance with one or more embodiments of the present invention, as shown in FIG. 3C, clamping unit 271 includes retaining ring 2701, spring 2702, shaft 2704, and securing tip 2703, wherein retaining ring 2701 and securing tip 2703 are connected to shaft 2704. Securing tip 2703 is adapted to engage HSA pivot top 1031 (shown in FIG. 1) when clamping unit 271 clamps HSA 100. In accordance with one or more such embodiments, when HSA pivot top 1031 has a convex shape, securing tip 2703 has a concave shape. In accordance with one or more alternative embodiments, if HSA pivot top 1031 has a concave shape, securing tip 2703 has a convex shape. Further, in accordance with one or more embodiments of the present invention, as shown in FIG. 3C, securing tip 2703 is attached to spring 2702, which spring 2712 may be compressed to enable securing tip 2703 to move vertically away from base 20, thereby buffering the downward force transmitted by clamp arm 272 through securing tip 2703 onto HSA pivot top 1031. Advantageously, this helps avoid damage to HSA pivot 103 that might be caused by excessive force being applied thereto.

As well known to one of ordinary skill in the art, retaining ring 2701, spring 2702, and shaft 2704 are commercially available parts, wherein spring 2702 can be designed and specified to provide a suitable force routinely and without undue experimention. Further clamp pivot 273, clamp arm 272, and securing tip 2713 can readily be made by a machine shop. In accordance with one or more embodiments of the present invention, clamp pivot 273, clamp arm 272, and clamping unit 271 (including retaining ring 2701, spring 2702, securing tip 2703, and shaft 2704) are made of 440 series stainless steel.

In accordance with one or more embodiments of the present invention, in use, HSA 100 is loaded onto fixture 200 by a human or robotic operator as follows: (a) clamp arm 272 is rotated counter-clockwise to provide unimpeded access to fixture 200 by HSA 100; (b) HSA pivot 103 is loaded onto HSA pivot support 41; (c) clamp pivot 273 is pulled vertically from its, receptacle in the surface of base 20 to move clamp arm 272 vertically away from the surface of base 20; (d) clamp arm 272 is rotated clockwise until clamping unit 271 reaches a position above HSA pivot top 1031 (shown in FIG. 1); and (e) clamp pivot 273 unit is released so that clamping unit 271 moves vertically towards base 20 to clamp HSA 100 (optionally, in addition, (i) retaining ring 2701 may be pulled to raise securing tip 2703 before clamping unit 271 reaches the clamping position; and (ii) retaining ring 2701 may then be released to allow spring 2702 to push securing tip 2703 downwards and buffer the force transmitted from clamp pivot 273).

In accordance with one or more embodiments of the present invention, after inspecting HSA 100, HSA pivot 103 is unclamped by the human or robotic operator as follows: (a) clamp pivot 273 is pulled vertically from its receptacle in the surface of base 20 to move clamp arm 272 vertically away from the surface of base 20—as a result, clamping unit 271 is removed from HSA pivot top 1031 (optionally, in addition, retaining ring 2701 may be pulled to raise securing tip 2703 from HSA pivot top 1031 prior to rotating clamp arm 272), and (b) clamp arm 272 is rotated counter-clockwise to move clamp arm 272 and clamping unit 271 away from HSA 100.

In accordance with one or more embodiments of the present invention, as shown in FIGS. 2 and 3A, fixture 200 includes HSA coil clamp 22 and HSA coil positioner 42 which, as described below, are used to secure and position HSA coil 104 (shown in FIG. 1) after HSA 100 has been loaded in the manner described above. In accordance with one or more such embodiments, HSA coil positioner 42 also provides a datum reference used in inspecting HSA 100. In accordance with one or more embodiments of the present invention, as shown in FIG. 3A, HSA coil 104 is secured between HSA coil clamp 22 and HSA coil positioner 42 by controlling the position of HSA coil clamp 22 using HSA coil clamp knob 21 (shown in FIGS. 2, 3A, and 3B). To load or unload HSA 100, respectively, a human or robotic operator: (a) advances HSA coil clamp knob 21 so that HSA coil clamp 22 is moved in a direction to clamp HSA coil 104 against HSA coil positioner 42; or (b) retracts HSA coil clamp knob 21 so that HSA coil clamp 22 is moved in a direction to unclamp HSA coil 104 from HSA coil positioner 42, respectively. In accordance with one or more embodiments of the present invention, HSA coil clamp knob 21 controls movement of HSA coil clamp 22 through a screw (not shown). The screw is installed inside base 20 and converts rotation of HSA coil clamp knob 21 into linear movement of HSA coil clamp 22 in accordance with any one of a number of methods that are well known to those of ordinary skill in the art. As well known to one of ordinary skill in the art, each of HSA coil clamp 22, HSA coil clamp knob 21, and the screw can readily be made by a machine shop. In accordance with one or more embodiments of the present invention, (a) HSA coil positioner 42 is a dowel pin that is commercially available and is made of 440 series stainless steel; (b) HSA coil clamp 22 is made of 440 series stainless steel; (c) HSA coil clamp knob 21 is made of Pomalux® plastic; and (d) the screw is made of 440 series stainless steel.

As shown in FIGS. 2, 3A and 3B, in accordance with one or more embodiments of the present invention, fixture 200 includes suspension separator 26 which separates first suspension 1021 and second suspension 1022 after HSA 100 has been loaded on fixture 200—thereby helping to prevent contact between, and damage to, first slider 1011 and second slider 1012. In accordance with one or more such embodiments, suspension separator 26 is inserted between the suspensions. Further, in accordance with one or more such embodiments, as shown in FIG. 2, suspension separator 26 is supported by separator holder 44, and its position is controlled by movment of suspension separator handle 25. As shown in FIG. 2, in accordance with one or more embodiments of the present invention, separator holder 44 includes a path that guides and limits movement of suspension separator handle 25, thereby guiding and limiting movement of suspension separator 26 in advancing towards and retracting away from HSA 100. In accordance with one or more embodiments of the present invention, suspension separator handle 25 is operated by a human or robotic operator. As one of ordinary skill in the art will readily appreciate, each of suspension separator 26, suspension separator handle 25, and separator holder 44 can readily be fabricated by a machine shop. In accordance with one or more embodiments of the present invention, suspension separator 26 is made of 440 series stainless steel, suspension separator handle 25 is made of Pomalux® plastic, and separator holder 44 is made of 300 series stainless steel. Further, the thickness of suspension separator 26 will be determined by a particular design of HSA 100.

As shown in FIGS. 2, 3A, and 3B, in accordance with one or more embodiments of the present invention, fixture 200 further includes slider separator 24 which separates the tips of first suspension 1021 and second suspension 1022 after HSA 100 has been loaded on fixture 200—thereby helping to prevent contact between, and damage to, first slider 1011 and second slider 1012. In accordance with one or more such embodiments, slider separator 24 is inserted between the tips, the tips being close to the sliders. Further, in accordance with one or more such embodiments, as shown in FIG. 2, slider separator 24 is supported by separator holder 44, and its position is controlled by movement of slider separator handle 23. As shown in FIG. 2, in accordance with one or more embodiments of the present invention, separator holder 44 includes a path that guides and limits movement of suspension separator handle 23, thereby guiding and limiting movement of slider separator 24 in advancing toward and in retracting away from HSA 100. In accordance with one or more embodiments of the present invention, slider separator handle 23 is operated by a human or robotic operator. As well known to one of ordinary skills in the art, each of slider separator 24 and slider separator handle 23 can readily be made by a machine shop. In accordance with one or more embodiments of the present invention, slider separator 24 is made of 440 series stainless steel, and slider separator handle 23 is made of Pomalux® plastic. Further, the thickness of slider separator 24 will be determined by a particular design of HSA 100.

As shown in FIG. 2, in accordance with one or more embodiments of the present invention, fixture 200 includes go/no-go gauge 28 that installed on base 20. Go/no-go gauge 28 is used to verify HSA coil height 17 and HSA coil thickness 18. In accordance with one or more embodiments of the present invention, as shown in FIG. 2, go/no-go gauge 28 includes first gauge member 281 and second gauge member 282, which first gauge member 281 and second gauge member 282 are caused to rotate and slide over and under HSA coil 104, respectively. If the movement is smooth, it is concluded that HSA coil 104 meets specification requirements of HSA coil height 17 and HSA coil thickness 18. If either of first gauge member 281 and second gauge member 282 collides with HSA coil 104, the human or robotic operator may conclude that HSA coil 104 does not meet thickness or height specifications. In accordance with one or more further embodiments of the present invention, first gauge member 281 and second gauge member 182 rotate simultaneously. As well known to one of ordinary skill in the art, go/no-go gauge 28 can readily be made by a machine shop using materials such as, for example and without limitation, 440 stainless steel and aluminum. The spacing between first and second gauge member 281 and 282, and the heights thereof, are determined by the thickness and height specifications for HSA coil 104 for a particular design of HSA 100.

In accordance with one or more embodiments of the present invention, all of the above-mentioned components of fixture 200 may be made of electrically conductive material such as, for example and without limitation, steel or electrically dissipative material, such as, for example and without limitation, Pomalux ( plastic, to avoid electrostatic discharge damage (ESD damage) to HSA 100.

FIGS. 4A, 4B, and 4C illustrate how inspection system 400 can inspect HSA 100 in three orientations using fixture 200. As shown in FIGS. 4A, 4B, and 4C, HSA 100 stands on platform 41 to present a first view, a second view, and a third view, respectively, by utilizing first standing mechanism 31, second standing mechanism 32, and third standing mechanism 33, respectively. In accordance with one or more embodiments of the present invention, image sensor 42 is a component of an inspection equipment (not shown) which further includes parts such as, for example and without limitation, a microscope, a computer, or a robot. Using image sensor 42, in accordance with any one of a number of methods that are well known to those of ordinary skill in the art, a human or robotic operator uses inspection system 400 to make measurements in each desired orientation (for example, measurements from datum references on the fixture that are relevant to a particular orientation to various measurement positions on the device held in the fixture at the particular orientation), i.e., carry out an inspection process. Such measurements, include the use of gauges such as, for example and without limitation, go/no-go gauge 28 described above. Further, in accordance with one or more embodiments of the present invention, image sensor 42 is commercially available from an inspection system supplier such as, for example and without limitation, NC Measurements Corporation (www.ncmeasurements.net) of Cary, N.C. Still further, in accordance with one or more embodiments of the present invention, inspection system 400 may be operated by a human or robotic operator, and fixture 200 may be turned by the human or robotic operator to change views presented to image sensor 42.

Advantageously, an inspection system that includes a fixture fabricated in accordance with one or more embodiments of the present invention may reduce the number of unloading and reloading actions in inspecting products, and therefore reduce the number of products that are damaged during inspection and increase productivity and yield of the products.

The embodiments of the present invention described above are exemplary. Many changes and modifications may be made to the disclosure recited above, while remaining within the scope of the invention. The scope of the invention should, therefore, be determined not with reference to the above description, but instead should be determined with reference to the appended claims along with their full scope of equivalents.

1. A fixture for use in inspecting a product, the fixture comprises:
a base comprising a first standing mechanism and a second standing mechanism; and
a clamp supported by the base which is adapted to secure the product on the base;
wherein the first standing mechanism is adapted to support the fixture on a platform in a first orientation; and
wherein the second standing mechanism is adapted to support the fixture on the platform in a second orientation.

2. The fixture of claim 1 wherein the base further comprises a third standing mechanism wherein the third standing mechanism is adapted to support the fixture on the platform in a third orientation.

3. The fixture of claim 1 wherein the first standing mechanism comprises a first side of the base.

4. The fixture of claim 1 wherein the first standing mechanism comprises a plurality of discrete units.

5. The fixture of claim 1 further comprising a separator which is affixed to the base and which is adapted to be disposed between two components of the product.

6. The fixture of claim 1 further comprising one or more datum references that are used in inspecting the product.

7. The fixture of claim 6 wherein the first standing mechanism comprises a standing surface that is substantial parallel to a plane that includes at least one of the one or more datum references.

8. The fixture of claim 1 wherein the base comprises one or more edges that provide one or more datum references that are used in inspecting the product.

9. The fixture of claim 1 wherein the base further comprises an elevated unit that provides a datum reference that is used in inspecting the product.

10. The fixture of claim 1 which further comprises a gauge that is used to verify if one or more dimensions of the product meets one or more specifications.

11. The fixture of claim 11 wherein the gauge is a go/no-go gauge.

12. The fixture of claim 1 wherein the clamp comprises an electrically conductive material.

13. The fixture of claim 1 wherein the clamp comprises an electrically dissipative material.

14. A system for inspecting a product comprising:
an image sensor;
a fixture adapted to present a first orientation and a second orientation of the product to the image sensor, the fixture comprising:
a base comprising a first standing mechanism and a second standing mechanism; and
a clamp supported by the base which is adapted to secure the product on the base;
wherein the first standing mechanism is adapted to support the fixture on a platform in the first orientation; and
wherein the second standing mechanism is adapted to support the fixture on the platform in the second orientation.
